(19) United States
(12) Patent Application Publication
(10) Pub. No.: US 2007/0058153 A1
(43) Pub. Date: Mar. 15, 2007

(54) Image improvement by using reflective mirrors between object and projection lens

(76) Inventor: Yijian Chen, Albany, CA (US)

Correspondence Address: Yijian Chen, 1049 Talbot Avenue, Albany, CA, 94706, US

(21) Appl. No.: 11/224,356

(22) Filed: Sep. 12, 2005

(51) Int. Cl. G03B 27/32

(52) U.S. Cl. 355/77; 355/55

(57) ABSTRACT

An optical method is invented to improve image quality by inserting different types and numbers of mirrors in different ways between the object and the projection lens. To demonstrate this method, we use an optical lithography system in which the mask is treated as the object to describe the involved physics of Fourier Optics. In general, this method is not limited only for lithography; its applications can be very wide including many other optical projection and display systems.

A method to improve image quality by inserting reflective mirrors between the object and projection lens is proposed. To demonstrate this method, we use an optical lithography system in which the mask is treated as an object to describe the physics of Fourier Optics. However, this method can be used not only for lithography; its applications can be very wide including many other optical projection and display systems.

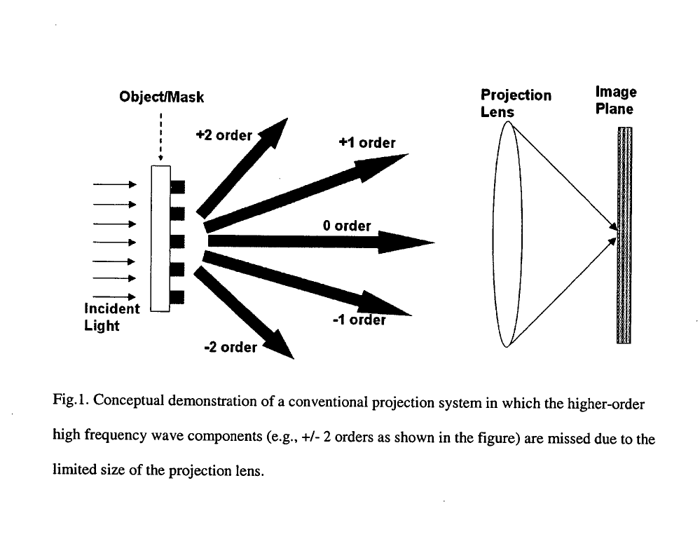

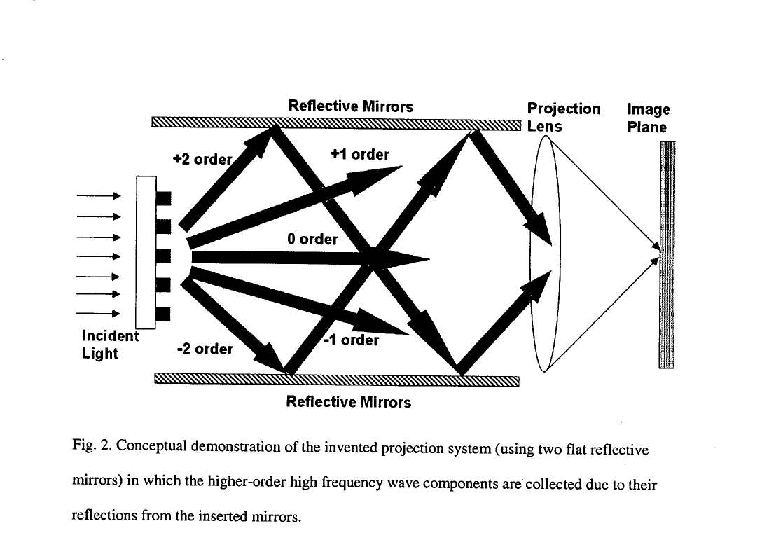

According to Fourier Optics [1, 2], the optical lithography system is a low-pass filter in which the high-frequency components of the mask patterns are filtered out due to the limited size of the projection lens. In FIG. 1, we show a conceptual 1-D projection system for easier demonstration purpose, but the principles we describe are also valid for more practical 2-D system. As shown in FIG. 1, we have a 1-D periodic structure on the mask and a plane-wave light is incident from left side. Light passing through the mask can be decomposed into many different orders (0, +/−1, +/−2, +/−3, +/−4, . . . , but only 0, +/−1, +/−2 orders are shown on FIGS. 1 and 2). Zero-order wave corresponds to the DC component of mask patterns without any modulation information, and higher-order waves correspond to the components with higher spatial frequency propagating at higher angles. As we can see from FIG. 1, the projection lens size is limited and can only catch the 0 and +/−1 orders while missing other high-order wave components. After 0 and +/−1 order wave components pass through the lens, they are combined together on the image plane to form the images. Nevertheless, the higher-frequency wave components are missed and the formed images are not exactly the same as the mask patterns thus image fidelity is somehow lost. Therefore, if we can find a way to collect and combine the higher-frequency wave components to form the images, the image quality can be improved.

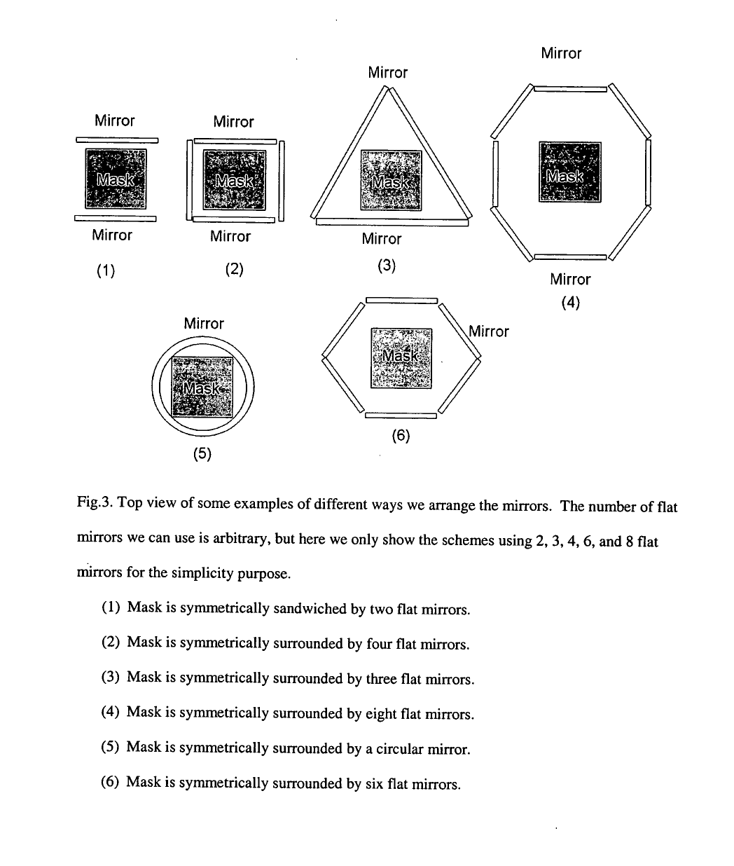

In FIG. 2, we demonstrate how we can improve the image quality by using reflective mirrors to surround the region between the mask/object and the projection lens. Here, we only show the 1-D case in which two mirrors are inserted, but different ways to arrange the mirrors for more practical 2-D lithographic system are shown in FIG. 3. The optical principles for image improvement is straight forward. As shown in FIG. 2, the higher-order high frequency wave components (only +/−2 orders are shown in the figure for the purpose of simplicity) are reflected back by the inserted mirrors and collected by the lens to form the image. Unlike the conventional lithography system (as shown in FIG. 1) in which the higher frequency wave components are missed, this new system is able to catch the higher-order components therefore resulting in better image quality such as an improved image fidelity. Different types (e.g., flat and spherical) and different number of mirrors can be arranged symmetrically or asymmetrically to obtain various images. In FIG. 3, some examples of symmetrical arrangement of mirrors are shown including one spherical mirror, but we can use many other schemes of mirror arrangement, depending on how many mirrors we use and how we put them together to surround the mask-to-lens region.

### REFERENCE

[1] J. W. Goodman, Introduction to Fourier Optics, McGraw-Hill, 1996.
[2] A. Wong, Resolution Enhancement Techniques in Optical Lithography, SPIE Press, Bellingham, Wash., 2001.

1. Yijian Chen claims that he invents the way to improve the image quality by inserting different types and numbers of mirrors in different ways between the object (or mask) and projection lens. Detailed description of the invention has been given in FIGS. 2 and 3, and mentioned in the text. The applications include lithography system and many other projection and display systems.
